(19) United States
(12) Patent Application Publication
(10) Pub. No.: US 2014/0143044 A1
(43) Pub. Date: May 22, 2014

(54) SYSTEM, METHOD AND PROGRAM PRODUCT FOR CONNECTING MERCHANTS WITH CUSTOMERS

(71) Applicant: Andrew Mark Klenert, Sunset, LA (US)

(72) Inventor: Andrew Mark Klenert, Sunset, LA (US)

(21) Appl. No.: 14/086,749

(22) Filed: Nov. 21, 2013

Related U.S. Application Data
(60) Provisional application No. 61/728,901, filed on Nov. 21, 2012.

(51) Int. Cl. G06Q 30/02

(52) U.S. Cl. CPC G06Q 30/0258
USPC 705/14.45; 705/14.56

(57) ABSTRACT

A system, method and program product for connecting merchants with customers may include a software program. Merchants and customers may create accounts within the system. The customer may create a list of preferred merchants. The merchant, once on the preferred list of the customer, may send out offers to those customers that have the merchant listed on their preferred list. The offer may be delivered and the customer may have a specific amount of time to respond to the offer. The customer may respond to the offer, and if accepting the offer, may receive a unique redeemable code. The merchant may be notified of the total number of accepted offers. The customer may then redeem the code with the merchant. In certain embodiments, the system may allow for tracking of offers and responses for both the customer and the merchant accounts.

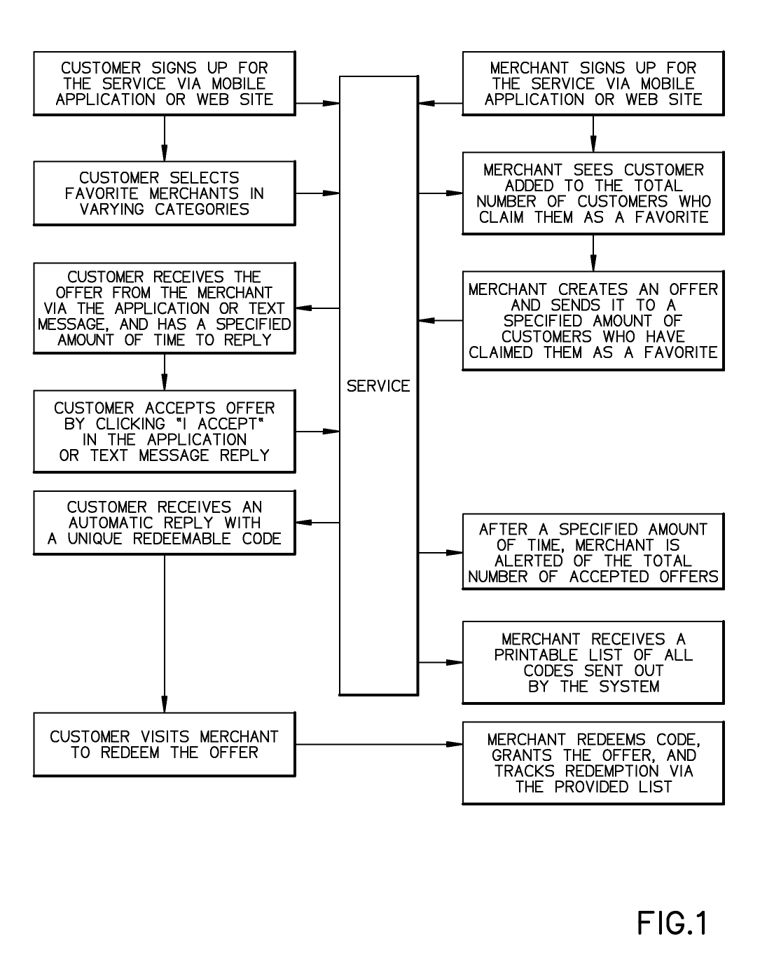

### CROSS-REFERENCE TO RELATED APPLICATION

This application claims the benefit of U.S. provisional application No. 61/728,901, filed Nov. 21, 2012, the contents of which are herein incorporated by reference.

### BACKGROUND OF THE INVENTION

The present invention relates to systems and methods for connecting merchants with customers and, more particularly, to a system that uses the internet and text messaging services to connect merchants with customers.

Currently, conventional discount programs for customers from merchants of various types typically fall into certain categories. First, discounts and specials are sent to reach various potential customers in print form, television advertisements, radio spots, and internet advertisements. Next, a more modern approach has been to use the internet via email and mobile applications to alert subscribers about vast numbers of specials and discounts in their area. Customers sign up for the service and are sent daily lists of a wide range of merchant services that they must scroll through to determine if they want or know the merchant or want to explore something new.

However, all of these programs and methods require that the customer sift through offers and discounts from a wide variety of merchants, many of whom they have never even heard about before. One limitation of such services is that customers spend time searching through services they do not even need in hopes of finding something they do need. Another limitation of such a service is that customers do not like or know about most of the merchants offering the discounts. A further limitation to the more current internet and email sign-up programs is that it requires the customer to pre-purchase the good or service, thus limiting the customer's ability to change their mind without penalty. Finally, since these service offers typically have a redemption time period of 30-90 days, the customer never knows whether they will see increased traffic at a merchant which could limit their experience. An example may be a coffee house offering ½ price coffee drinks may sell thousands of discounts and then customers show up en mass thus creating long lines, long waits, poor service, and the like.

From the merchant's point of view, there are many drawbacks to such offers as well. First, the programs can be quite costly. Running print, radio, and television advertisements are expensive. Second, using modern programs that use sign-up services will promote the merchant's offers for a significant cost, typically about 50% of the revenues collected. These additional fees add a tremendous burden onto the merchant who is already discounting his good or service and now to also lose 50% of the revenue generated. Next, emails are so often ignored in our fast paced world that many offers are simply not seen. Another problem is over saturation. A merchant offering a large discount through such large coverage is potentially showing itself as desperate to the public, thus undervaluing its products in the customer's corporate mind. Finally, since a merchant is required to give a wider redemption period to the customer as an expectation for a pre-purchase, the merchant can never be truly prepared for mass redemption in an unpredictable time. Their service and employees may become strained, the service may suffer, and the merchant could get terrible reviews on internet review sites.

As can be seen, there is a need for a system and method for connecting merchants with customers that allows for targeting of participating customer's choices of preferred businesses that may allow these preferred businesses to create “discounts” for these customers, and allows instant tracking and review of the “discounts” offered.

### SUMMARY OF THE INVENTION

In one aspect of the present invention, a system for connecting merchants with customers comprises: a computer having a user interface; a program product comprising machine-readable program code for causing, when executed, the computer to perform the following process steps: prompting at least one customer to create and access an account; saving the customer created account to a database; prompting at least one merchant to create and access an account; saving the merchant created account to a database; establishing from information received from the customer, a list of at least one preferred merchant associated with the customer comprising at least one merchant offering goods and services; saving the created list of at least one preferred merchant to the database; causing to be delivered to at least one customer up to a specified number of offers based on offers available from each merchant; causing to be delivered to the merchant a response from at least one customer to the at least one offer for a good or service; and causing to be delivered to the customer a unique redeemable code if the offer was accepted.

These and other features, aspects and advantages of the present invention will become better understood with reference to the following drawings, description and claims.

### BRIEF DESCRIPTION OF THE DRAWINGS

The FIGURE is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system, method and program product for connecting merchants with customers that may include a software program. Merchants and customers may create accounts within the system. The customer may create a list of preferred merchants. The merchant, once on the preferred list of the customer, may send out offers to those customers that have the merchant listed on their preferred list. The offer may be delivered and the customer may have a specific amount of time to respond to the offer. The customer may respond to the offer, and if accepting the offer, may receive a unique redeemable code. The merchant may be notified of the total number of accepted offers. The customer may then redeem the code with the merchant. In certain embodiments, the system may allow for tracking of offers and responses for both the customer and the merchant accounts.

In certain embodiments, the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

As is illustrated in the FIGURE, to begin use of the system, method and program product for connecting merchants with customers, the customer may download the application to a computer, smart phone, tablet computer, or some other mobile device. The customer may complete a website registration. The merchant may download the application to a computer, smart phone, tablet computer, or some other mobile device. The merchant may complete a website registration. During the registration process, the customer may select at least one favorite or preferred merchant in various categories. The merchant may see the customer added to a total number of customers who claim that particular merchant as a favorite or preferred merchant. The merchant may then create an offer and send it to a specified amount of customers who have claimed the merchant as a favorite or preferred merchant. The offer may be sent out to a batch of customers. The batches may be in, but not limited to, groups of 100 customers. The customer may receive the offer from the favorite merchant via the application or a short message service (SMS) text message, and may have a specified amount of time to reply to the offer. The specified amount of time may be, but not limited to, twenty minutes. In certain embodiments, the customer may accept the offer by clicking on a link or button within the application such as “I accept” or the like. In certain embodiment, the customer may accept the offer by replying to the SMS text message. The customer may then receive an automatic reply with a unique redeemable code. After a specified amount of time, the merchant may be alerted to the total number of accepted offers by customers. The merchant may receive a printable list of all the unique redeemable codes sent out by the system. The customer may visit the merchant to redeem the offer. The merchant may redeem the code and grant the offer. The merchant may also at this time track redemption of the offer via the provide list.

In certain embodiments, the customer may only be able to receive offers from those merchants that the customer prefers. The merchant may begin to use the service after receiving a specified amount of favorite merchant statuses from customers in order to send out offers. Offers may be sent out in various sized batches of customers. Once the customer sees the offer placed, they may accept, reject or ignore the offer. If the customer accepts or rejects the offer, the merchant may be notified by the system sending feedback to the merchant.

In certain embodiments, the system may monitor acceptance rates of the customers to offers made over a period of time. The customers may be categorized within a merchant database as higher or lower rated based on their frequency of acceptance. Customers may also track past offers which may allow the customers to determine whether or not to follow a particular merchant as a favorite merchant based on the merchant's offer values and frequency. Both the merchant and the customer may be incentivized to use the system more often due to the tracking tool of the system. If the customer removes the merchant from their list, the particular merchant may no longer send offers to that customer.

In certain embodiments, the system and method may allow for merchants that have a good or service to connect with customers who are already loyal to that good or service at a time when the merchant may need immediate revenue increases. An example is that a restaurant, bar or nightclub that is expecting a slow evening may use the present invention in order to lure more loyal customers in that very night. In certain embodiments, a theater, bowling alley, or other entertainment center desiring higher than expected revenues on a particular day may use the system and method to secure more customers. In certain embodiments, a grocery store or boutique store may use the system and method to draw in customers when they need to reduce overflow stock.

In certain embodiments, the system may generate revenue from the services provided to the merchants through a per use fee. In certain embodiments, the system may generate revenue from the services provided to the merchants through monthly subscription charges.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for connecting merchants with customers comprising:
a computer having a user interface;
a program product comprising machine-readable program code for causing, when executed, the computer to perform the following process steps:
prompting at least one customer to create and access an account;
saving the customer created account to a database;
prompting at least one merchant to create and access an account;
saving the merchant created account to a database;
establishing from information received from the customer, a list of at least one preferred merchant associated with the customer comprising at least one merchant offering goods and services;
saving the created list of at least one preferred merchant to the database;
causing to be delivered to at least one customer up to a specified number of offers based on offers available from each merchant;
causing to be delivered to the merchant a response from at least one customer to the at least one offer for a good or service; and
causing to be delivered to the customer a unique redeemable code if the offer was accepted.

2. The system of claim 1, wherein the offer is delivered by SMS message.

3. The system of claim 1, wherein the offer is delivered by a notice from the account through a mobile application.

4. The system of claim 1, further comprising the step of sending a list of all unique redeemable codes sent out to the at least one customer to the merchant.

5. The system of claim 1, wherein the delivery to the at least one customer up to a specified number of offers based on offers available from each merchant occurs in batches.

6. The system of claim 1, wherein the offer may only be delivered to a customer if the merchant is on the customer's preferred merchant list.

7. The system of claim 1, further comprising the step of monitoring acceptance rates of the customers to offers made over a period of time.

8. The system of claim 1, further comprising the step of categorizing customers in the database for a merchant based on the customer's frequency of acceptance.

9. The system of claim 1, further comprising the step of tracking past offers for the customer which allows the customer to determine whether or not to follow a particular merchant as a preferred merchant based on the merchant's offer values and frequency.

10. The system of claim 1, further comprising the step of the redemption of the unique redeemable code by the customer with the merchant.

11. The system of claim 1, further comprising the step of allowing the merchant the use of the service after a specified amount of customers designate that merchant as a preferred merchant.

12. The system of claim 1, wherein the computer accesses the database by at least one of internet, extranet, intranet, host server, and internet cloud.

13. The system of claim 1, further comprising the step of generating revenue from the service as provided to the merchants via a per use fee.

14. The system of claim 1, further comprising the step of generating revenue from the service as provided to the merchants via monthly subscription charges.
